(19) United States
(12) Patent Application Publication
(10) Pub. No.: US 2007/0038502 A1
(43) Pub. Date: Feb. 15, 2007

(54) Efficient Frontier and Attainment Rate for Business Transformation Outsourcing

(75) Inventors: Steven M. Kagan, Burr Ridge, IL (US); John Arthur Ricketts, Clarendon Hills, IL (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/203,323

(22) Filed: Aug. 11, 2005

(51) Int. Cl. G06Q 99/00; G07G 1/00; H04M 3/51; G06F 17/30

(52) U.S. Cl. 705/10; 705/1; 705/11

(57) ABSTRACT

A method and system for establishing an Efficient Frontier (EF) and Attainment Rate (AR) for Business Transformation Outsourcing (BTO) is presented. EF is the maximum service level achievable at a point in time for a specific business process or business process area. AR is the pace at which the EF can be reached from an initial value. Clients, outsourcers, and third-parties determine whether proposals are infeasible (above EF) or inefficient (below AR). Fact-based discussions of the merits and limitations of various implementation initiatives are supported. A determination is made as to whether there are any business segments to which different EF and AR apply. Any underlying factors for the EF and AR of each business segment are determined, and any change (rise or fall) of EF over time is predicted to maintain an optimally accurate EF and/or AR for each business segment.

### BACKGROUND OF THE INVENTION

1. Technical Field

The present invention relates in general to the field of outsourcing business operations. In particular, the present invention relates to a method and system for determining whether an outsourcing bid is both feasible and efficient.

2. Description of the Related Art

Enterprises today must be dynamic and flexible to remain competitive. One recognized way to do so is to outsource operations that fluctuate (such as seasonal work) or are too expensive to maintain in-house (such as a telemarketing department). To provide such resources, outsourcers routinely submit bids for handling different business processes to potential enterprise clients.

Unfortunately, proposals made to potential clients by the outsourcers often lack sufficient empirical evidence of feasibility or efficiency, and rarely any clear specification of which factors have the greatest leverage. Outsourcers who fail to recognize their inability to handle a client's needs could suffer from “Winner's Curse,” in which they soon learn that their submitted solution is undeliverable and/or the bid price is too low. Similarly, clients who outsource operations to an inadequate outsourcer could suffer “Buyer's Remorse,” in which the winning outsourcer is unable to meets its committed service levels and/or cost savings to the client.

### SUMMARY OF THE INVENTION

Thus, there is a need for a method and system that enables clients, outsourcers, and third-parties to determine whether proposals are infeasible and/or inefficient according to fact-based discussions of the merits and limitations of various alternatives. In response to this need, the present invention presents a method and system for establishing an Efficient Frontier (EF) and Attainment Rate (AR) for Business Transformation Outsourcing (BTO). EF is the maximum service level achievable at a point in time for a specific business process or business process area. AR is the pace at which the EF can be reached from an initial value. The present invention enables clients, outsourcers, and third-parties to determine whether proposals are infeasible (above EF) or inefficient (below AR). Moreover, the present invention supports fact-based discussions of the merits and limitations of various implementation initiatives.

In a preferred embodiment, the present invention determines if there are any business segments to which different EF and AR apply. Any underlying factors for the EF and AR of each business segment are determined, and any change (rise or fall) of EF over time is predicted to maintain an optimally accurate EF and/or AR for each business segment.

Thus, the method presented allows an outsourcer to determine if a service bid is too aggressive (infeasible) or not aggressive enough (inefficient) relative to the best performance possible.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a chart that illustrates how an Efficient Frontier (EF) and an Attainment Rate (AR) are determined empirically;

FIG. 2 illustrates how segmentation and other factors underlying the EF and AR are used to generate quantitative models that compute the EF and AR based on specific values of the factors;

FIG. 3 is a chart showing alternative ERs and ARs generated by the quantitative models;

FIG. 4 is a chart showing illustrates how the EF and AR are used to evaluate whether proposals are feasible and efficient;

FIG. 5 is a flow-chart illustrating a method for creating and applying EF and AR;

FIGS. 6a-b are flow-charts showing steps taken to deploy software capable of executing the steps shown in FIG. 5;

FIGS. 7a-c are flow-charts showing steps taken to deploy in a Virtual Private Network (VPN) software that is capable of executing the steps shown in FIG. 5;

FIGS. 8a-b are flow-charts showing steps taken to integrate into a computer system software that is capable of executing the steps shown in FIG. 5; and

FIGS. 9a-b are flow-charts showing steps taken to execute the steps shown in FIG. 5 using an on-demand service provider.

### DETAILED DESCRIPTION OF THE PREFERRED EMBODIMENT

The present invention is a method and system for establishing Efficient Frontiers and Attainment Rates for Business Transformation Outsourcing. The method uses models to understand the factors underlying the Efficient Frontier and Attainment Rate, and thereby support better decisions.

Business Transformation Outsourcing (BTO) occurs when an outsourcer [1] assumes responsibility for one or more business processes previously done by the client or third parties and [2] transforms the client's business via information technology, business process redesign, and best practices. Primary benefits of BTO include substantially higher service levels, lower costs, and elimination of distractions from the client's core business. Examples of business process areas amenable to BTO include Finance and Administration, Customer Relationship Management, Human Resources, Procurement, Insurance Back Office, Banking Back Office, and Service After Sale.

Efficient Frontier (EF) is the maximum service level achievable at a point in time for a specific business process area. EF can be determined empirically from current and historical data, and can be projected for future periods and/or specific client characteristics via models.

Service Index (SI) is a generic term for the particular service level measurements that are applicable to each business process area. In HR, for example, an appropriate SI is employees per HR resource. For other business process areas, the SI may be entirely different. In CRM, for instance, appropriate SIs are average handle time and customer satisfaction level.

Attainment Rate (AR) is the pace at which EF can be reached from an initial SI. Thus, AR can be expressed as an overall rate, such as “it generally takes X years to rise from a typical initial SI to EF.” But since AR is not constant over time—at least until it reaches EF—AR can also be expressed as an instantaneous rate, such as “expected progress toward EF in year 1 is A %, in year 2 is B %, etc.”

Factors underlying ER and AF explain why particular actions are effective or ineffective. For instance, conditions within the client and its environment constrain what can be accomplished with BTO. Furthermore, some changes can be implemented faster than others, but there are always tradeoffs between speed, cost, and effectiveness that affect the ultimate benefit.

The present invention answers several fundamental questions, including: (1) Where is the Efficient Frontier (EF) for a particular business process area? (2) How fast can an enterprise get there (i.e., what is the maximum Attainment Rate (AR))? (3) Are there segments to which different EF and AR apply? (4) What factors underlie EF and AR? (5) Will EF rise over time, and if so, how far?

Determining the Efficient Frontier and Attainment Rate

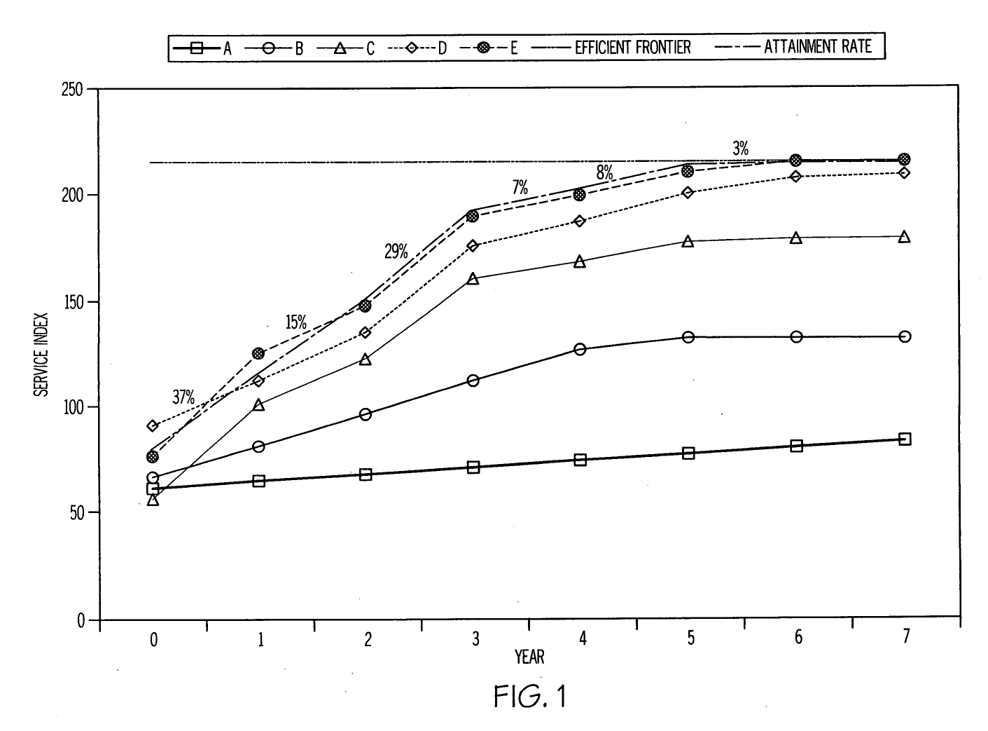

With reference now to the figures, FIG. 1 illustrates how the Efficient Frontier (EF) and Attainment Rate (AR) are determined empirically. A through E represent the Service Indices (SI) of various enterprises (A-E) over time.

Enterprise A is pursuing incremental process improvement internally. Enterprise B is pursuing Business Process Outsourcing (BPO), which provides cost savings up to a point but no substantial business transformation. The rest of the enterprises (C-E) are pursuing Business Transformation Outsourcing (BTO).

Enterprise E ultimately attains the highest SI, and it does so at the fastest rate, so it defines both EF and AR for this business process area. Thus, the performance of the other enterprises is less efficient than EF and AR.

Though not shown in FIG. 1, it is possible for different enterprises to define EF and AR, particularly in the early years. For instance, if enterprise C's SI rose more than enterprise E's during year 1, enterprise C's SI change would define AR for that period.

Note that a significant improvement for enterprise E during year 1 due to transition of business processes to the outsourcer is followed by a smaller improvement in year 2 and then a larger improvement in year 3. This pattern is common for BTO because year 2 is often a key transformational year. Subsequent years then maintain and extend the transformation, but the slope of AR ultimately declines as SI becomes asymptotic with EF. Thus, AR is not necessarily a smooth curve.

Segmentation

If the sample contains enterprises with Service Indices (SIs) at distinct levels, it may be preferable to determine different EFs and/or ARs for appropriate subsamples. For instance, if enterprise C in FIG. 1 were many times larger than enterprise A, and operating globally rather than domestically, separate EFs and ARs for these subsamples might lead to more accurate predictions.

One approach to determining EF and AR is to classify enterprises into segments defined a priori based on industry, geography, size, and/or markets. This approach has the advantage of comparing each enterprise to other enterprises generally accepted as its peers. However, this approach may be ineffective if enterprises in each such segment are not truly alike in terms of what enables and constrains the EF and AR for their segment.

An alternative is to identify segments based on SI clusters. That is, if clusters of enterprises emerge based on similar SI levels, regardless of their a priori segment membership, those enterprises are instead segmented according to their SI cluster. This alternative increases the probability that the EF and AR identified for the cluster do indeed represent the best possible performance for that cluster. Furthermore, this alternative can be helpful in identifying factors that affect EF and AR if enterprises in each cluster are found to have like business designs or best practices.

Business Design and Environmental Factors

Business design and environmental factors enable or constrain EF. Some business design choices are made by the enterprise's executives and managers based on customer needs, supplier capabilities, and competitors' business designs, of course. But other business design choices are dictated or limited by environmental factors such as shareholders, governments, and employees.

Business design factors include but are not limited to: 1) Customer Selection and Value Proposition—which customers are targeted and what the offer is; 2) Value Capture/Profit Model—how profit is captured from each customer; 3) Strategic Control—how sustainability is built into the business design; 4) Scope—which activities and assets are required; and 5) Organizational Systems—means by which the enterprise conducts its operations.

Environmental factors include but are not limited to: 1) Legislation/regulation—financial reporting, work visas, offshoring; 2) Workforce—unions, work councils, professional licensing; 3) Skills and knowledge—education, training, experience, expertise; 4) Information technology—complexity, stability, suitability; and 5) Business culture—morale, values, structure, leadership, vision, compensation.

Business design and environmental factors are important because they ultimately determine whether an enterprise can reach the EF for its segment. For instance, an enterprise which retains non-core business processes that could be performed better, faster, and cheaper by an outsourcer is committing itself to a business design that may be considerably different from an enterprise already at EF. Thus, if an enterprise is unwilling or unable to transform its business design, it may be limiting itself to SIs below EF. On the other hand, for an enterprise to raise the prevailing EF, an unconventional business design may be the key.

Best Practices and Implementation Factors

In a nutshell, best practices are activities that enable high AR. That is, if an enterprise's current or target business design would enable it to reach EF, and its objective is to do so in the shortest possible time, that enterprise typically must follow best practices. For example, automation of some tasks previously performed manually is a typical best practice.

This definition of best practices has an empirical basis because they are the activities that can be shown to maximize AR for enterprises en route to EF. This is in contrast to common usage of the term, wherein any popular activity can be called a best practice without evidence that it actually produces the assumed benefit.

Furthermore, as the term is used here, best practices are a coherent collection of activities demonstrated to produce results when used together. This too contrasts with common usage, wherein an implicit assumption is that activities which appear beneficial in isolation will be even more beneficial in combination, despite the absence of evidence of compatibility and synergy.

For Business Transformation Outsourcing (BTO), best practices can be grouped by phase. These phases preferably include: 1) Transition—retained activities, outsourced activities, eliminated activities; 2) Transformation—process redesign, IT leverage, change management; and 3) Steady state—capacity management, service level management.

BTO best practices often span organizational boundaries between the client and the outsourcer. For instance, if self-service via web-based systems is a best practice supported by the outsourcer for routine inquiries and transactions, the client must foster such self-service in order to reserve service center calls for non-routine matters.

Whereas best practices are required to attain high AR, other implementation factors must be met to attain normal AR. For example, establishing a project office to oversee multiple initiatives is an important implementation factor, but project offices are so common that merely having one is not in itself a best practice. On the other hand, if a particular project office organization or management method brought about an extraordinary AR, they would be considered best practices.

Raising the Efficient Frontier and Accelerating the Attainment Rate

As noted above, business designs and environmental factors limit EF. For example, the value proposition offered to customers always requires a sustained level of support. Likewise, the ongoing organizational systems required to meet a particular financial reporting requirement, such as Sarbanes-Oxley, may keep EF from rising.

Also as noted above, best practices enable AR. For example, it takes time to replace legacy information technology (IT) with state-of-the-art IT, and even then transaction throughput rates are finite. Likewise, it takes time to replace bad practices with best practices, and even then SI may not reach 100% during peak periods.

Best practices for reaching EF are dynamic because there is no single route to EF, but EF itself changes infrequently. That is, it takes a substantial and sustained technological or environmental shift to raise EF. Thus, EF may remain constant for years. Furthermore, EF can even decline, if legislation, regulation, or workforce matters make it substantially harder to transform a business.

As noted above, the present invention includes both a method and a system. The system is comprised of models. The method explains how to generate and use those models.

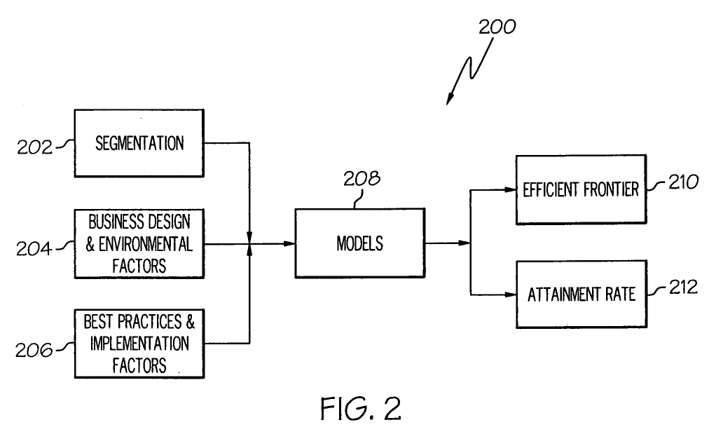

Reference is now made to FIG. 2, which illustrates how the above-described factors underlying Efficient Frontier (EF) 210 and Attainment Rate (AR) 212 are used by a system 200 to generate quantitative models that compute EF 210 and AR 212 based on specific values of the factors. As shown, segmentation 202, business design and environmental factors 204, and best practices and implementation factors 206 are incorporated into models 208 to generate EF 210 and AR 212. With such models, EF 210 and AR 212 can not only be estimated for specific subsamples but also for combinations of factors not directly represented in the database, such as a client that's smaller than the global subsample but larger than the domestic subsample.

The models 208 that generate EF 210 and AR 212 operate as follows.

Structure—the models 208 determine which drivers, constraints, and decisions are strongly related. For example, business culture may be twice as strong as Information Technology (IT) at constraining EF 210, and models 208 will factor this in when computing EF 210 and/or AR 212.

Prediction—Given specific factors, models 208 determine what will EF 210 and AR 212 be in future periods. For example, if component architecture is expected to raise EF another 10% in year 3, then models 208 will factor this in when computing EF 210 and/or AR 212.

Simulation—How does uncertainty affect the forecast? For example, if workforce changes are delayed, it could take up to 18 months more for AR 212 to reach EF 210, and models 208 will factor this in when computing EF 210 and/or AR 212.

Optimization—Given a set of drivers and constraints, what decisions maximize EF 210 and AR 208? For example, if a client has executed numerous mergers and acquisitions, migration to a shared service center maximizes EF 210 and AR 208, then models 208 will factor this in when computing EF 210 and/or AR 212.

These EF and AR models are distinct from many statistical models, which describe common properties of a sample, such as the average Service Index (SI) and average time to reach it. Instead, these models focus on enterprises that are literally on the leading edge. Hence, only data from the most efficient enterprises enters into the determination of EF and AR.

These EF and AR models are also distinct from many benchmarking models, which seek to define values such as the 50^{th} and 80^{th} percentiles of a sample. The former may be taken as an indicator of minimally acceptable performance, while the latter indicates attainment of substantially better performance. In contrast, these EF and AR models focus on enterprises at the 100^{th} percentile.

Modeling the Efficient Frontier and Attainment Rate

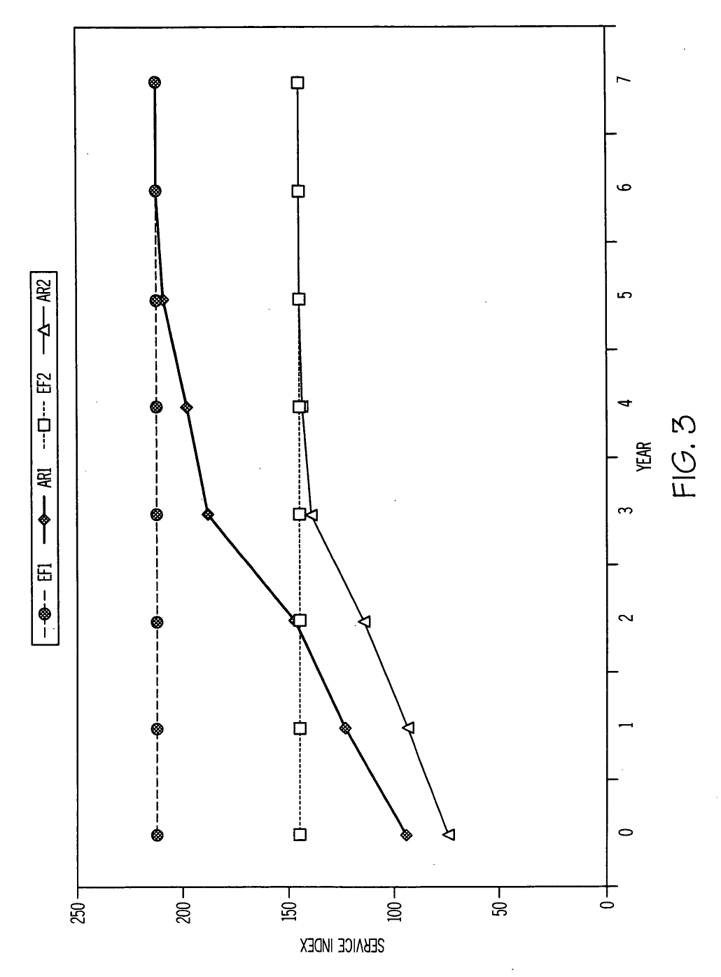

FIG. 3 illustrates alternative Efficient Frontiers (ER) and Attainment Rates (AR) generated by models. EF1 and AR1 could represent global enterprises, which get more leverage from shared service centers. EF2 and AR2 could represent domestic enterprises, which require more differentiated services and therefore create fewer economies of scale. Note that the initial Service Index for AR1 is somewhat higher than AR2. Nonetheless, EF1 is markedly higher than EF2. Note further that AR2 converges on EF2 at year 4, while AR1 doesn't converge on EF1 until year 6. Hence, the appropriate EF and AR must be applied to each enterprise considering BTO.

Using the Efficient Frontier and Attainment Rate

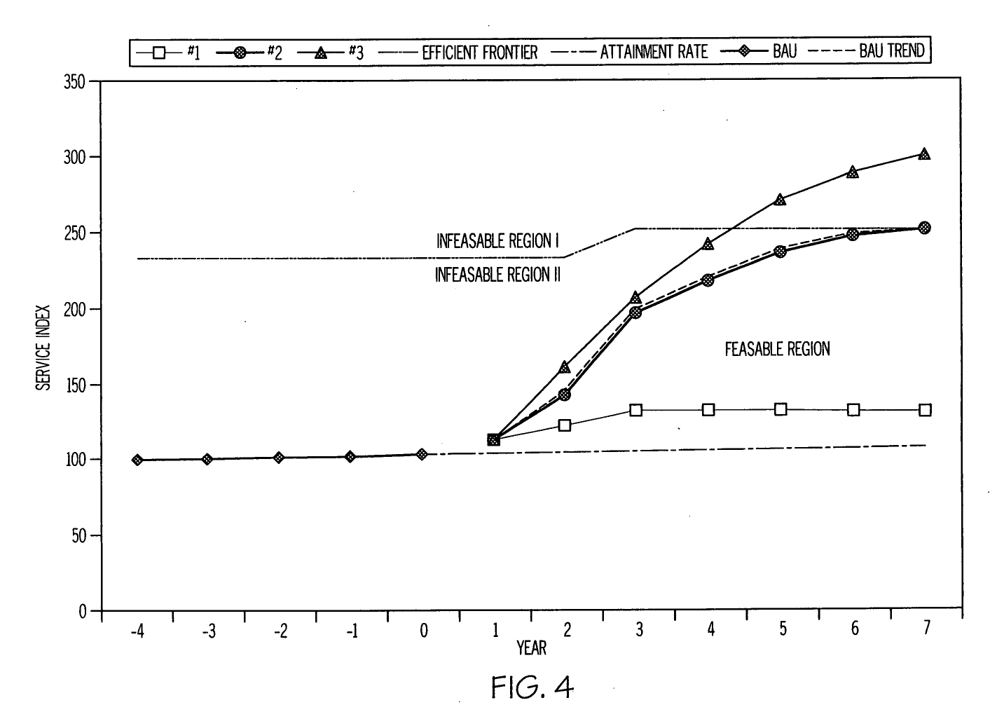

Attention is now directed to FIG. 4, which illustrates how the Efficient Frontier (EF) and Attainment Rate (AR) are used to evaluate whether proposals are feasible and efficient. As shown, SI values above EF are in Infeasible Region I. Values at or below EF but above AR are in Infeasible Region II. Values substantially below AR are in the Feasible Region—but they're inefficient. Value at AR are on the edge of the Feasible Region—and therefore most efficient.

BAU represents “Business As Usual” for the enterprise in question. Alternative #1 is a Business Process Outsourcing (BPO) proposal, (Alternative) #2 is a Business Transformation Outsourcing (BTO) proposal, and (Alternative) #3 is a competitor's BTO proposal.

Alternative #1 is somewhat more efficient than BAU, but #2 is considerably more efficient than #1. Conversely, #3 is infeasible not only because it extends beyond EF but also because it exceeds AR. That is, even if #3 rose only to EF, the fact that it proposes to reach EF in 4.5 years rather than 7 years makes it infeasible.

Note that EF is expected to rise in year 3, during the proposed engagement. The assessment of feasibility and efficiency does take such a change into account.

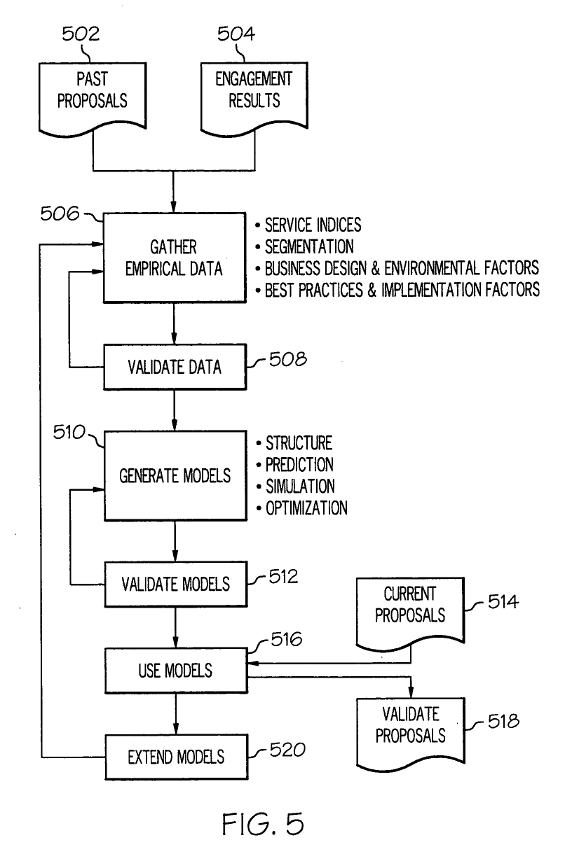

With reference now to FIG. 5, a flow-chart is presented illustrating the method for creating and applying Efficient Frontier (EF) and Attainment Rate (AR) models. As shown at block 506, empirical data is gathered from past proposals 502 and engagements results 504 covering appropriate Service Indices (SI) as well as the underlying factors including Segmentation, Business Design and Environmental Factors, and Best Practices and Implementation Factors.

As shown at block 508, the data is then validated, with erroneous values being corrected or discarded, and irreproducible results (e.g., extraordinary outcomes attained with proprietary technology that cannot be licensed or an unsustainable business decision, such as abandonment of a key product or market) are eliminated. The step shown in block 506 is repeated if necessary to ensure validity.

As shown at block 510, models are then generated. This step of model generation includes 1) comparing projected versus realized EF and AR; 2) creating stochastic models if uncertainty is too high to support deterministic models; 3) creating simulation models if complexity is too high to support analytic models.

As shown at block 512, the models are then validated. Validation includes 1) comparing proposals to their corresponding engagement results; 2) determining what works as predicted and what doesn't; 3) identifying factors that should be incorporated in future models; and 4) repeating step 3 if necessary to ensure validity.

As shown at block 516, models are then used as described above in the section titled “Using the Efficient Frontier and Attainment Rate,” paying particular attention to how the efficient enterprises overcame constraints. Drivers are identified that differentiate efficient enterprises from the others. Decisions that lead to greater efficiency are also identified. Current proposals 514 are input to the model such that the process shown in block 516 outputs validated proposals 518.

As shown in block 520, the models are then extended to new solutions, industries, geographies, etc.

It should be understood that at least some aspects of the present invention may alternatively be implemented in a computer-readable medium (preferably tangible) that contains a program product capable of executing the above described steps. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

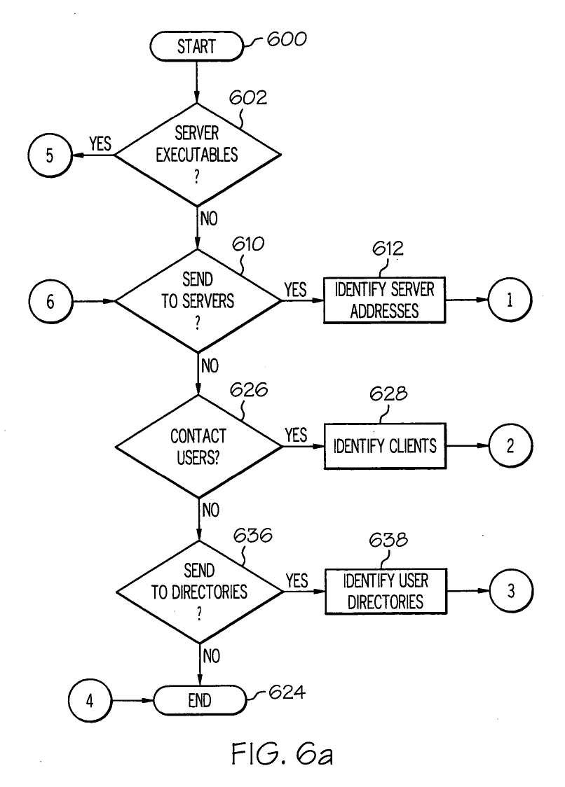

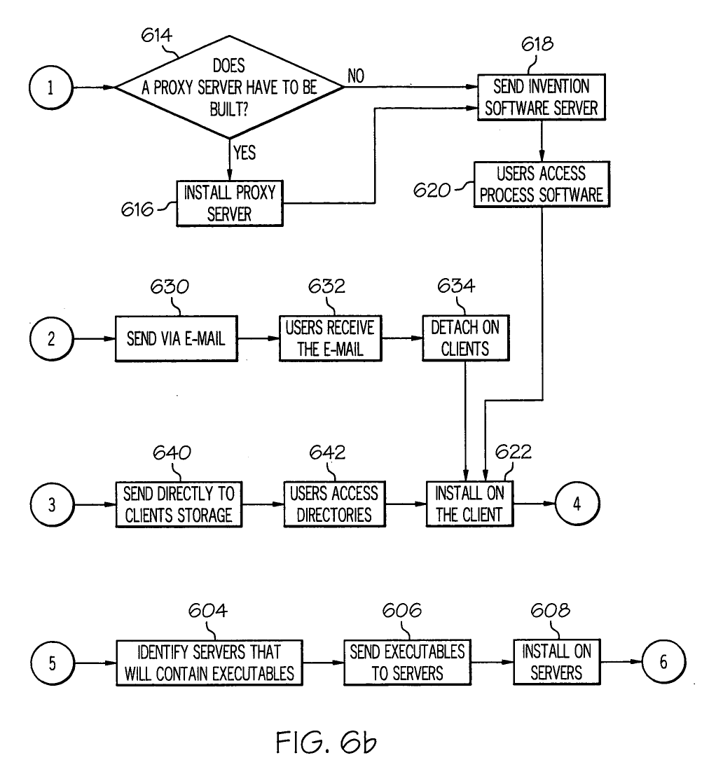

Thus, the method described herein, and in particular as shown in FIG. 5, can be deployed as a process software. Referring now to FIG. 6, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether to the process software will be sent directly to user directories on their client computers (query block 636). If so, the user directories are identified (block 638). The process software is transferred directly to the user's client computer directory (block 640). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

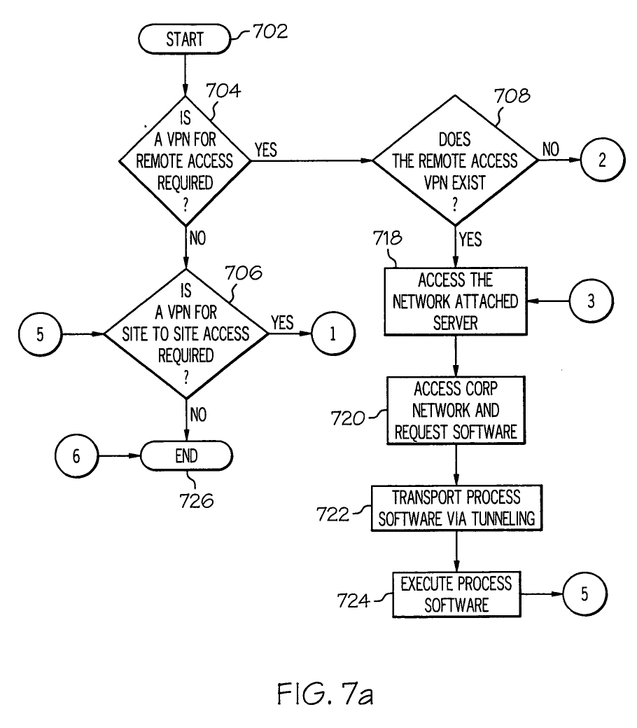

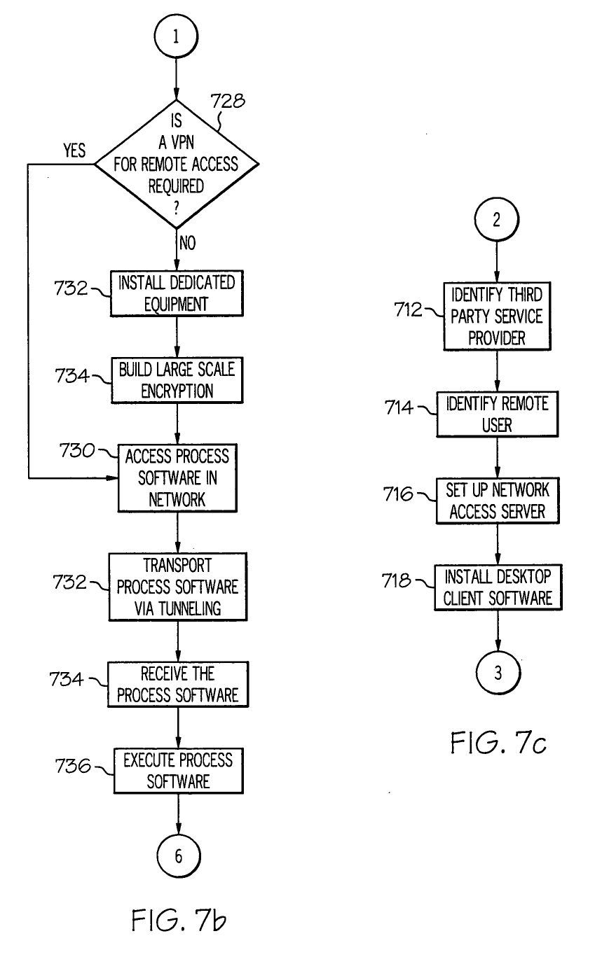

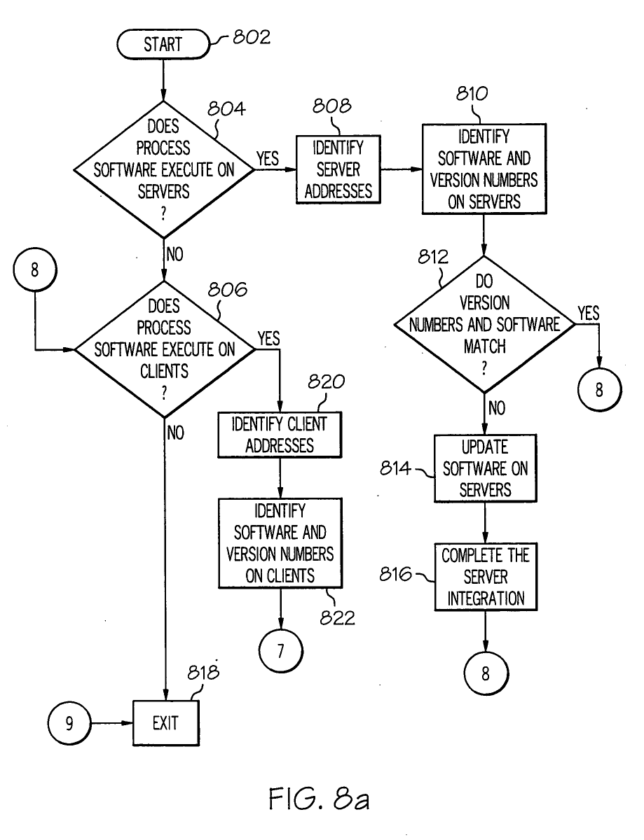

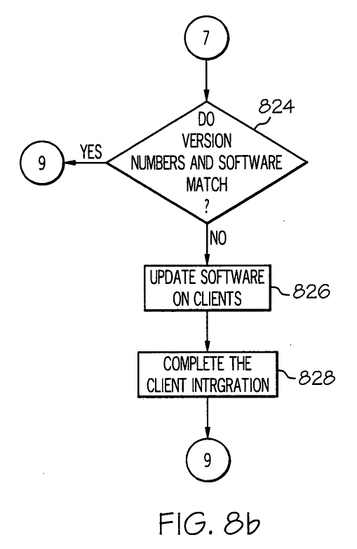

The process for such VPN deployment is described in FIG. 7. Initiator block 702 begins the Virtual Private Network (VPN) process. A determination is made to see if a VPN for remote access is required (query block 704). If it is not required, then proceed to (query block 706). If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is the process software is divided into packets and each packet including the data and protocol is placed within another packet (block 722). When the process software arrives at the remote user's desktop, it is removed from the packets, reconstituted and then is executed on the remote users desktop (block 724).

A determination is then made to see if a VPN for site to site access is required (query block 706). If it is not required, then proceed to exit the process (terminator block 726). Otherwise, determine if the site to site VPN exists (query block 728). If it does exist, then proceed to block 730. Otherwise, install the dedicated equipment required to establish a site to site VPN (block 732). Then build the large scale encryption into the VPN (block 734).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site users desktop (block 736). The process then ends at terminator block 726.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

For a high-level description of this process, reference is now made to FIG. 8. Initiator block 802 begins the integration of the process software. The first thing is to determine if there are any process software programs that will execute on a server or servers (block 804). If this is not the case, then integration proceeds to query block 806. If this is the case, then the server addresses are identified (block 808). The servers are checked to see if they contain software that includes the operating system (OS), applications, and Network Operating Systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally if there is missing required software, then it is updated on the server or servers in the step shown in block 814. The server integration is completed by installing the process software (block 816).

The step shown in query block 806, which follows either the steps shown in block 804, 812 or 816, determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made is the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

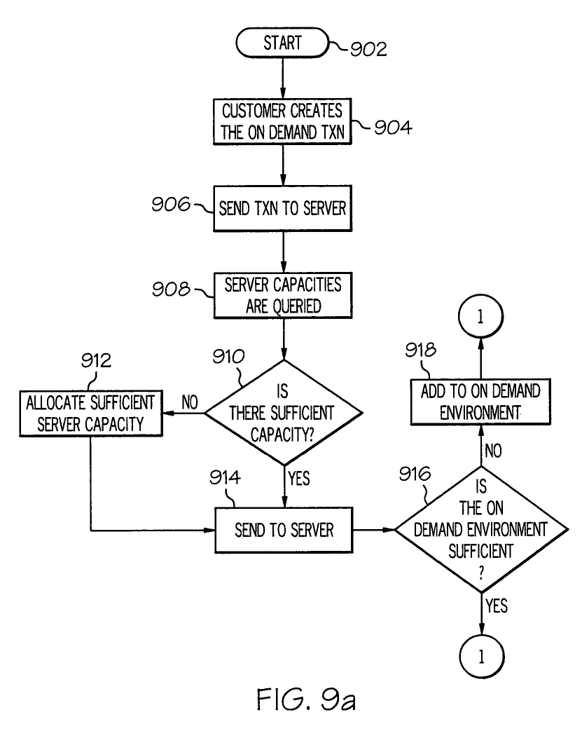

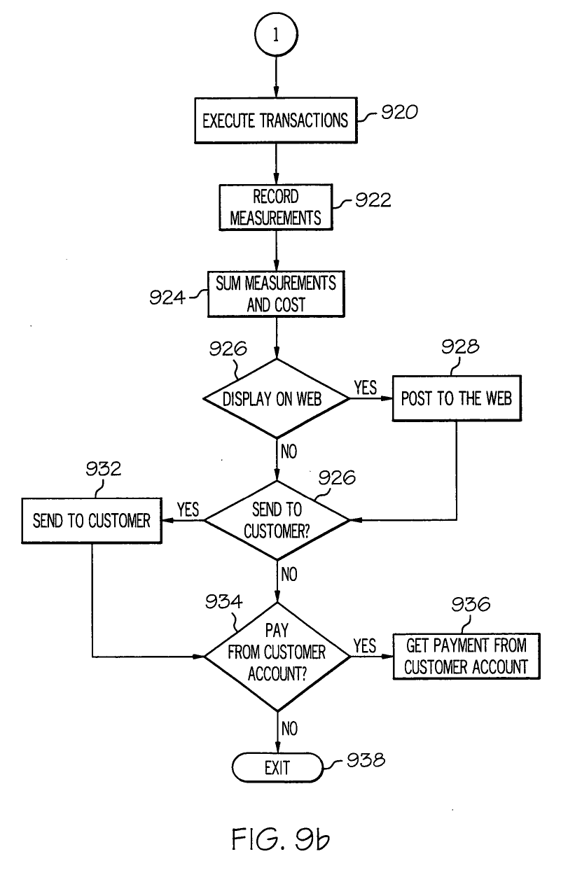

With reference now to FIG. 9, initiator block 902 begins the On Demand process. A transaction is created than contains the unique customer identification, the requested service type and any service parameters that further specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient Available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

While the invention has been particularly shown and described with reference to a preferred embodiment, it will be understood by those skilled in the art that various changes in form and detail may be made therein without departing from the spirit and scope of the invention.

What is claimed is:

1. A method for determining whether an outsourcing bid is both feasible and efficient by establishing Efficient Frontiers (EF) and Attainment Rates (AR), wherein EF is a maximum service level achievable at a point in time for a specific business process area in the enterprise, and wherein AR is a pace at which EF can be reached from an initial Service Index (SI), where SI is a service level measurement applicable to the specific business process area in the enterprise, the method comprising:
determining an EF for a particular business process area;
determining an initial SI for the particular business process area;
determining an AR for the particular business process area for reaching the EF from the SI; and
utilizing the EF, SI and AR to determine whether a bid is feasible and efficient for the particular business process area.

2. The method of claim 1, wherein a single enterprise has multiple particular business process areas.

3. The method of claim 2, wherein each of the multiple particular business process areas are classified as segments defined a priori based on industry, geography, and size.

4. The method of claim 1, wherein the EF is defined based on business design factors and environmental factors of an enterprise that is utilizing outsourcing.

5. The method of claim 4, wherein the business design factors include which customers are targeted, how profit is captured from each customer, how sustainability is built into a business design, which activities and assets are required by an enterprise, and means by which the enterprise conducts its operations.

6. The method of claim 4, wherein the environmental factors include current and pending legislation affecting the enterprise, type of workforce in the enterprise, types of skills and knowledge in the workforce of the enterprise, and type of information technology used by the enterprise.

7. The method of claim 1, further comprising:
creating a simulation of an outsourcing of activities from the enterprise using the EF, SI and AR.

8. The method of claim 7, wherein the simulation includes results of prior EFs, SIs and ARs from other enterprises.

9. The method of claim 1, further comprising visually evaluating a graphical representation of the ER, SI and AR to determine whether a bid is feasible and efficient.

10. The method of claim 9, further comprising:
utilizing the EF to determine a feasible region and an infeasible region in the graphical representation, wherein EFs in the infeasible region indicate that outsourcing is economically impractical or physically impossible, and wherein EFs in the feasible region indicate that the outsourcing is economically practical and physically possible.

11. A machine-readable medium having a plurality of instructions processable, by a machine embodied therein, wherein said plurality of instructions, when processed by said machine causes said machine to perform a method for determining whether an outsourcing bid is feasible and efficient by establishing Efficient Frontiers (EF) and Attainment Rates (AR), wherein EF is a maximum service level achievable at a point in time for a specific business process area in the enterprise, and wherein AR is a pace at which EF can be reached from an initial Service Index (SI), where SI is a service level measurement applicable to the specific business process area in the enterprise, the method comprising:
determining an EF for a particular business process area;
determining an initial SI for the particular business process area;
determining an AR for the particular business process area for reaching the EF from the SI; and
utilizing the EF, SI and AR to whether a bid is feasible and efficient.

12. The machine-readable medium of claim 11, wherein a single enterprise has multiple particular business process areas.

13. The machine-readable medium of claim 12, wherein each of the multiple particular business process areas are classified as segments defined a priori based on industry, geography, and size.

14. The machine-readable medium of claim 11, wherein the EF is defined based on business design factors and environmental factors of an enterprise that is utilizing outsourcing.

15. The machine-readable medium of claim 14, wherein the business design factors include which customers are targeted, how profit is captured from each customer, how sustainability is built into a business design, which activities and assets are required by an enterprise, and means by which the enterprise conducts its operations.

16. The machine-readable medium of claim 14, wherein the environmental factors include current and pending legislation affecting the enterprise, type of workforce in the enterprise, types of skills and knowledge in the workforce of the enterprise, and type of information technology used by the enterprise.

17. The machine-readable medium of claim 11, wherein the method further comprises:
creating a simulation of an outsourcing of activities from the enterprise using the EF, SI and AR.

18. The machine-readable medium of claim 17, wherein the simulation includes results of prior EFs, SIs and ARs from other enterprises.

19. The machine-readable medium of claim 11, wherein the processable instructions are deployed to a server from a remote location.

20. The machine-readable medium of claim 11, wherein the processable instructions are provided by a service provider to a customer on an on-demand basis.
